(19) United States
(12) Patent Application Publication
(10) Pub. No.: US 2007/0162503 A1
(43) Pub. Date: Jul. 12, 2007

(54) Post-at-will network dialoging system

(76) Inventors: Erh-Jen Hou, Taipei (TW); Chun-Wei Lien, Taipei (TW)

Correspondence Address: PRO-TECHTOR INTERNATIONAL SERVICES, 20775 NORADA CT., SARATOGA, CA, 95070, US

(21) Appl. No.: 11/328,914

(22) Filed: Jan. 9, 2006

(51) Int. Cl. G06F 17/00

(52) U.S. Cl. 707/104.1

(57) ABSTRACT

A post-at-will network dialoging system is a kind of dialog software which is provided with a post-at-will tag, and is composed of a recipient software, a recipient software installation component, a Microsoft IE browser, and a set of HTML tag naming rules in association with an operation of the recipient software. After the recipient configures the dialog software, it can be put in on-line and waiting. On the other hand, at the originator, a user can conduct a dialog with the recipient, by just clicking on and downloading a picture containing a web site of post-at-will tag, without being required to become a member.

### BACKGROUND OF THE INVENTION

a) Field of the Invention

The present invention relates to a post-at-will network dialoging system, and more particularly to a network dialoging system wherein a non-member only needs to click on a dialog software with the “post-at-will” tag to conduct a dialog, without being required to be a member. The dialog process is simple and convenient, and the non-member can have an option to use that dialog software to join the member.

b) Description of the Prior Art

Conventionally, when dialing a network phone, a SKYPE software should be downloaded, and an earphone and a microphone should be installed, in order to proceed a network dialog. If a non-member needs to dialog with a member, he or she should join the member and download the program to be installed before conducting the dialog, which is a very troublesome and time consuming process.

### SUMMARY OF THE INVENTION

The primary object of the present invention is to provide a network dialoging system wherein if a non-member is to conduct a dialog with a member having a dialog software of present invention, he or she only needs to click on a download picture in a web site containing the “post-at-will” tag to conduct the dialog, which is a simple and convenient process.

Another object of the present invention is to enable an ordinary people (non-member) to see a dialog button and to conduct a dialog with a member having a dialog software at any time, as long he or she uses a computer, which is installed with the dialog software of present invention, to browse the web site. In addition, even the non-member switches to a different web page or turns off the IE browser during the dialog, the dialog in process will still not be affected.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of system architecture of the present invention.

FIG. 2 shows a block diagram of a process of the present invention.

FIG. 3 shows a schematic view of an application status of the present invention.

### DETAILED DESCRIPTION OF THE PREFERRED EMBODIMENTS

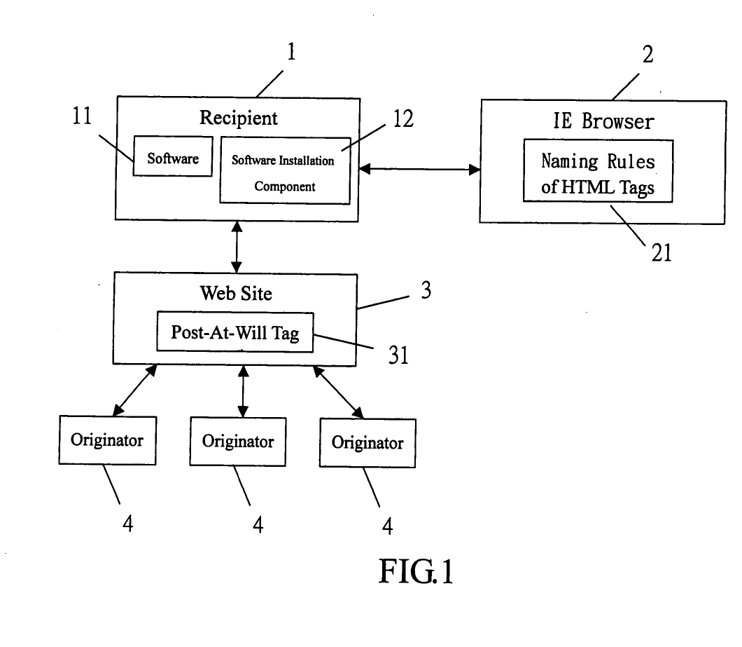

Referring to FIG. 1, the present invention comprises a recipient 1, an IE browser 2, a web site 3, and a plurality of originators 4, wherein the recipient 1 refers to a computer user who needs to use the “post-at-will” tag to receive an incoming call, and the originator 4 refers to a computer use who would like to click on a dialog button on the web site to conduct the dialog. Software 11 in the recipient 1 provides a resident function and a clean and neat operating interface, including all the core functions of present invention. Most essentially, the recipient software 11 can monitor the IE browser 2. A software installation component 12 inside the recipient 1 provides a process of on-line installation on a web page and is provided with features of easy operation and fast installation. The IE browser 2 is a kind of Microsoft IE browsing tool, an interior of which is installed with a set of naming rules 21 of HTML (Hyper Text Markup Language) tags associated with an operation of the recipient software 11.

Profound knowledge is not required for an installer (i.e., the recipient 1) of the web site 3 supported by the recipient software 11 to allow his or her own web site 3 to support the network dialoging; he or she only needs a simple copy and paste, and totally without any script language or a great deal of complicated files. Of course, the recipient 1 has to apply an account from an authority web site of network dialoging; therefore, the recipient 1 can freely use a post-at-will tag 31 in the web site 3 to receive calls from the originator 4, under an approved URL (Universal Resource Locator).

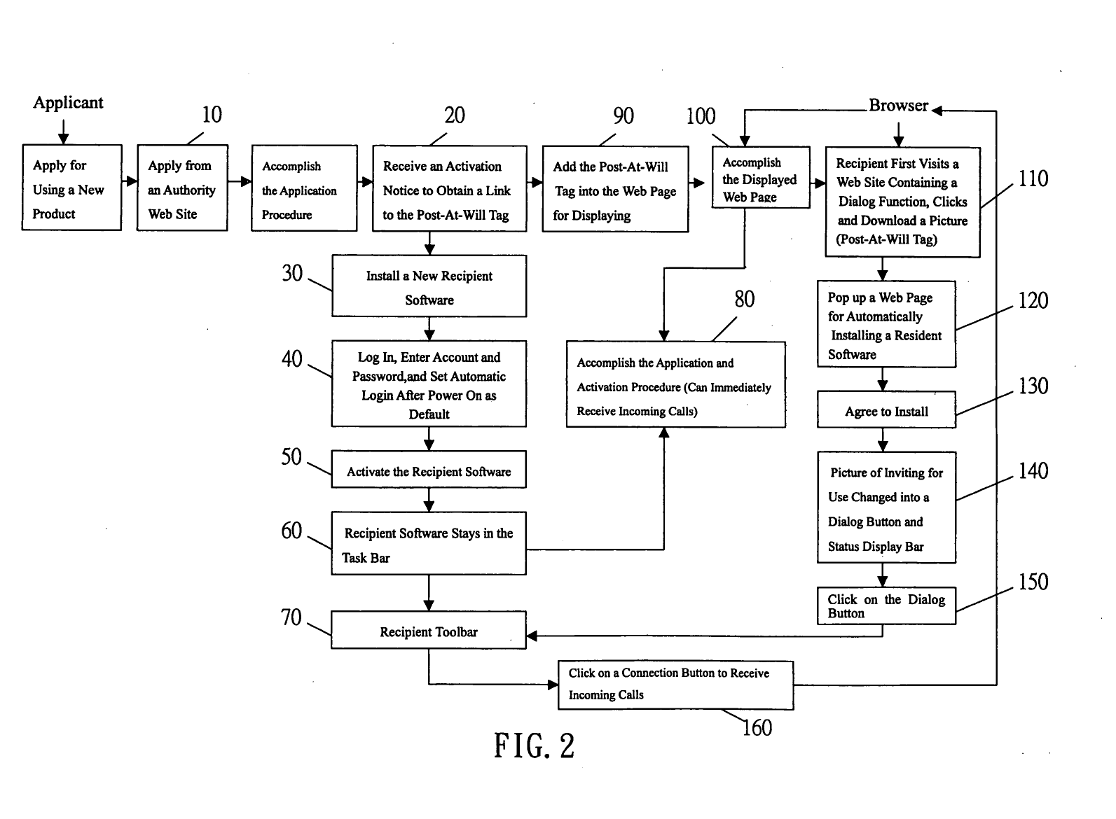

Referring to FIG. 2, it shows a block diagram of implementation process of the present invention. First of all, an applicant applies from an authority web site for a recipient software which has been successfully registered with his or her own e-mail address 10. When the recipient (i.e., a user who wants to use the post-at-will tag to receive an incoming call) receives a notice of activation to obtain a link to URL of post-at-will tag which has been authorized 20, the recipient can write the post-at-will tag of his or her own unique identification texts into any web site which can post the HTML syntax, such as the Yahoo!Shopping site. The post-at-will tag is an HTML tag having a hyperlink to a picture attracting users to explore and can be posted around on web pages. After installing an originator software 30, the user will log in, enter an account and password, and set an automatic login after power on as the default 40. Next, a recipient software is activated 50 and it will be staying in a task bar 60, which can proceed to a recipient toolbar 70 or to an accomplishment of application and activation procedure 80 for immediately receiving an incoming call. After receiving an activation notice to obtain a link to URL of post-at-will tag 20 as described above, the process can proceed to adding the post-at-will tag to a web page for displaying 90, and then to an accomplishment of the displayed web page 100. Next, when the recipient of browser first visits the web site containing a recipient dialog function, he or she can click on and download a picture containing the post-at-will tag 110, or the procedure can proceed to the accomplishment of application and activation procedure 80 for receiving the incoming call. When a user clicks on and downloads the picture 110, a web page of an automatic installation of resident software 120 (the web page is an Active X component, which is a specification of software components proposed by the Microsoft company located at Redmond, Wash. State) will be popped up, and if he or she agrees to install, the post-at-will tag will be changing from the picture of inviting for use to a dialog button and a status display bar 140. When the user clicks on the dialog button 150, he or she can conduct a dialog with the recipient toolbar 70 which can also dialog with the browser through a function of clicking on a connection button for receiving the incoming call 160.

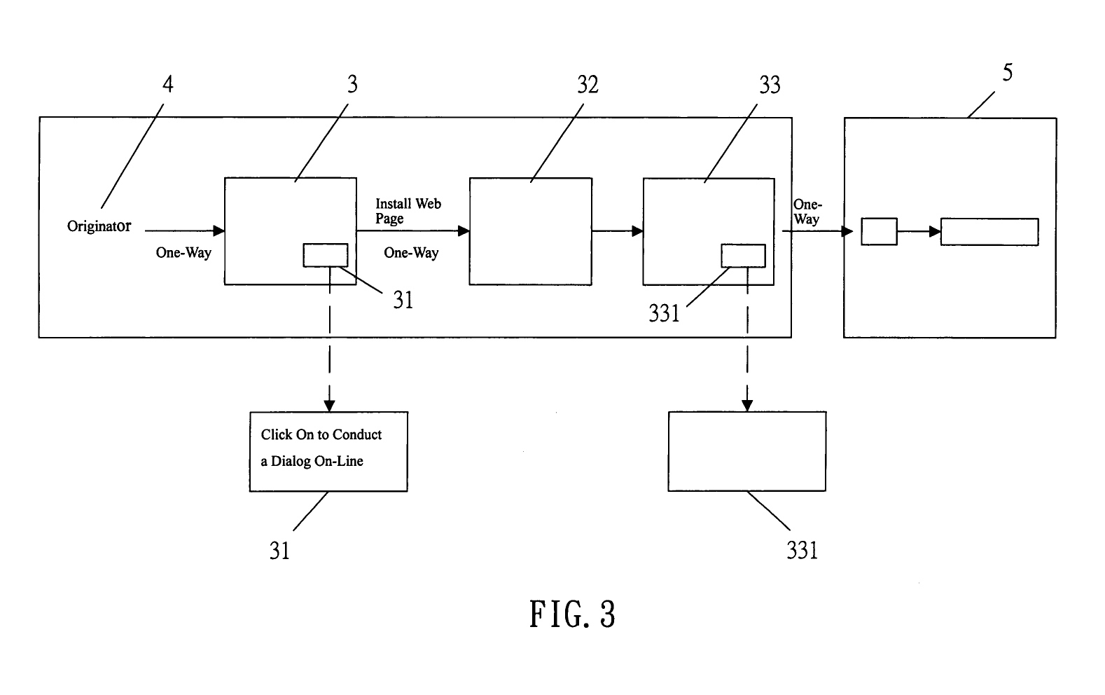

Referring to FIG. 3, it shows a schematic view of a real operation of the present invention. An originator (i.e., a user who is browsing the web site) 4 visits in one-way a web site containing the “post-at-will tag” 3, and the web site 3 is displaying the post-at-will tag 31. As long as the originator 4 clicks on and downloads a picture, he or she can conduct a dialog with a recipient, which is a simple and convenient process. If the originator 4 of a non-member also requires to have his or her own web site of “post-at-will tag,” he or she has to install a web page (Active X) on-line in one-way to become a member 32. When the originator 4 becomes a member and a web site 33 contains a post-at-will tag 331, he or she can provide originators (users who are browsing the web site) of other non-members to click on and download the pictures for conducting dialogs. On the other hand, the originator of non-member can also click on and download a picture containing the web site of post-at-will tag 33, and click on a dialog picture 5 in one-way to conduct a dialog with a recipient or originator of the member.

Furthermore, functions such as an automatic signature file, a one-to-many broadcasting, a dialog recording and voice message can be successively added into the dialog software of present invention, wherein the one-to-many broadcasting is a primary work of an ordinary Q4, and a phone book of conventional IM (Instant Message) software and a user list function can be used to analyze web page data and to dynamically generate a list of contact person, in association with browsing the web site, so as to facilitate a quick browsing and a direct clicking on dialoging parties.

Accordingly, the present invention is a kind of network dialoging system, wherein an ordinary non-member can conduct a dialog with a member by only visiting a web site containing the post-at-will tag, and clicking on a picture of the post-at-will tag on a download web page, without a requirement of becoming the member.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A post-at-will network dialoging system including a recipient software which provides a resident function and an operation interface; a recipient software installation component which is located in the recipient software and provides an on-line web page installation procedure; an IE browser which can be monitored by the recipient software and is provided with naming rules of tags in association with an operation of the recipient software; a web site which is supported by the recipient software and is provided with a post-at-will tag; at least one originator which can click on and download a picture of post-at-will tag in the web site to conduct a dialog with the recipient.

2. The post-at-will network dialoging system according to claim 1, wherein the recipient refers to a user who requires using the post-at-will tag to receive an incoming call.

3. The post-at-will network dialoging system according to claim 1, wherein the originator refers to a user who requires clicking on a dialog button on the web site to conduct a dialog.

4. The post-at-will network dialoging system according to claim 1, wherein the naming rules of tags of IE browser are the naming rules of HTML (Hyper Text Markup Language) tags.

5. The post-at-will network dialoging system according to claim 1, wherein the post-at-will tag is an HTML tag containing a hyperlink to a picture.

6. The post-at-will network dialoging system according to claim 1, wherein an automatic signature file device can be added into the recipient software.

7. The post-at-will network dialoging system according to claim 1, wherein a one-to-many broadcasting device can be added into the recipient software.

8. The post-at-will network dialoging system according to claim 1, wherein a dialog recording device can be added into the recipient software.

9. The post-at-will network dialoging system according to claim 1, wherein a voice message device can be added into the recipient software.
